(19) United States
(12) Patent Application Publication
(10) Pub. No.: US 2006/0002347 A1
(43) Pub. Date: Jan. 5, 2006

(54) Offset satellite communication cell arrays with orthogonal polarizations

(76) Inventors: Mark D. Thompson, Hood River, OR (US); Steve Bucca, Westminster, CO (US)

Correspondence Address: IPSOLON LLP, 805 SW BROADWAY, #2740, PORTLAND, OR, 97205, US

(21) Appl. No.: 11/039,971

(22) Filed: Jan. 20, 2005

Related U.S. Application Data
(63) Continuation of application No. 10/846,952, filed on May 13, 2004, now abandoned.
(60) Provisional application No. 60/470,546, filed on May 13, 2003.

(51) Int. Cl. H04B 7/216

(52) U.S. Cl. 370/335; 370/316

(57) ABSTRACT

A communication satellite has multiple communication signal amplifiers coupled to multiple transmit horns that transmit communication signals to multiple corresponding geographic cells. The satellite includes a first set of communication signal amplifiers and transmit horns that cooperate to deliver multiple distinct communication signals of a first polarization to a first array of multiple adjacent geographic cells having interstices or intersections between them. The satellite also includes a second set of communication signal amplifiers and transmit horns that cooperate to deliver multiple distinct communication signals of a second polarization to a second array of multiple adjacent geographic cells having interstices or intersections between them. The first and second polarizations are orthogonal to each other, such as horizontal and vertical polarizations or right- and left-circular polarizations. In addition, the adjacent geographic cells of the first array are generally centered at the interstices between and overlap the cells of the second array, and the cells of the second array are generally centered at the interstices between and overlap the cells of the first array.

### FIELD OF THE INVENTION

The present invention relates to satellite communication systems and, in particular, to a communication satellite that provides offset arrays of geographical cells with communication signals of orthogonal polarizations.

### BACKGROUND AND SUMMARY OF THE INVENTION

A conventional communication satellite in geosynchronous orbit has a communication signal receiving system and a communication signal transmitting system. The receiving system includes a satellite receiving reflector that receives multiple communication uplink signals from one or more terrestrial transmitting stations and concentrates the signals at corresponding ones of multiple receiving horns, which pass the communication uplink signals through an input filter system to a satellite low noise amplifier (LNA) and downconverter system.

A communication multiplexer system receives the low noise amplified and frequency converted uplink signals and channelizes and routes the signals to the transmitting system for transmission to terrestrial recipient stations. The transmitting system typically includes an amplifier system, which may include traveling wave tube (TWT) amplifiers, to provide high reliability, high power output amplification. The outputs of the high power amplifier system are connected through an output filter system to one or more transmit horns for transmission as downlink signals via a satellite transmit reflector.

The conventional communication satellite directs narrow zone communication signals to recipient stations in multiple cells over a satellite telecommunication region. The cells correspond to different geographic areas within the region and may form a dense-packed or “honeycombed,” optionally overlapping, arrangement that minimizes or eliminates the portions of region not covered by a cell. Next adjacent cells typically receive distinct communication signals or sub-bands. However, potentially interfering cells are typically within the telecommunication region. As a result, cells can have interference-induced signal-to-noise ratios (S/Nint) at a maximum of about 20 dB at the center of a cell with decreases to about 12 dB at the peripheries of the cells. A consequence of such a range of signal-to-noise ratios within a cell is that signal integrity and reliability is decreased at the cell peripheries.

Accordingly, the present invention includes a communication satellite having multiple communication signal amplifiers coupled to multiple transmit horns that transmit communication signals to multiple corresponding geographic cells. The satellite includes a first set of communication signal amplifiers and transmit horns that cooperate to deliver multiple distinct communication signals of a first polarization to a first array of multiple adjacent geographic cells having interstices or intersections between them.

The satellite also includes a second set of communication signal amplifiers and transmit horns that cooperate to deliver multiple distinct communication signals of a second polarization to a second array of multiple adjacent geographic cells having interstices or intersections between them. The first and second polarizations are orthogonal to each other, such as horizontal and vertical polarizations or right- and left-circular polarizations. In addition, the adjacent geographic cells of the first array are generally centered at the interstices between and overlap the cells of the second array, and the cells of the second array are generally centered at the interstices between and overlap the cells of the first array.

The satellite of the present invention provides reduced interference between cells that receive potentially interfering signals by interposing cells that receive non-interfering signals. As a result, communication signals are delivered with increased uniformity in the signal-to-noise ratios, which can noticeably improve signal reliability or allow the finite communication signal power to be allocated to more areas.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a block diagram of a prior art implementation of a communication satellite for geosynchronous orbit.

FIG. 2 is a prior art illustration of a satellite telecommunications region having multiple cells.

FIGS. 3 and 4 illustrate respective first and second cell patterns of geographic cells that receive communication signals with orthogonal polarizations according to the present invention.

FIGS. 5A and 5B illustrate an overlapping arrangement of the cell patterns of FIGS. 3 and 4.

FIG. 6 illustrates a close-packed arrangement of central regions of cells in the overlapping arrangement of the cell patterns in FIGS. 5A and 5B.

FIG. 7 is an illustration of an array of geographic cells arranged in a right-regular array with lower packing efficiency.

FIG. 8 is a circuit block diagram of a satellite communication signal transmitting system.

FIG. 9 is a circuit block diagram of a satellite communication signal receiving system.

### DETAILED DESCRIPTION OF PREFERRED EMBODIMENTS

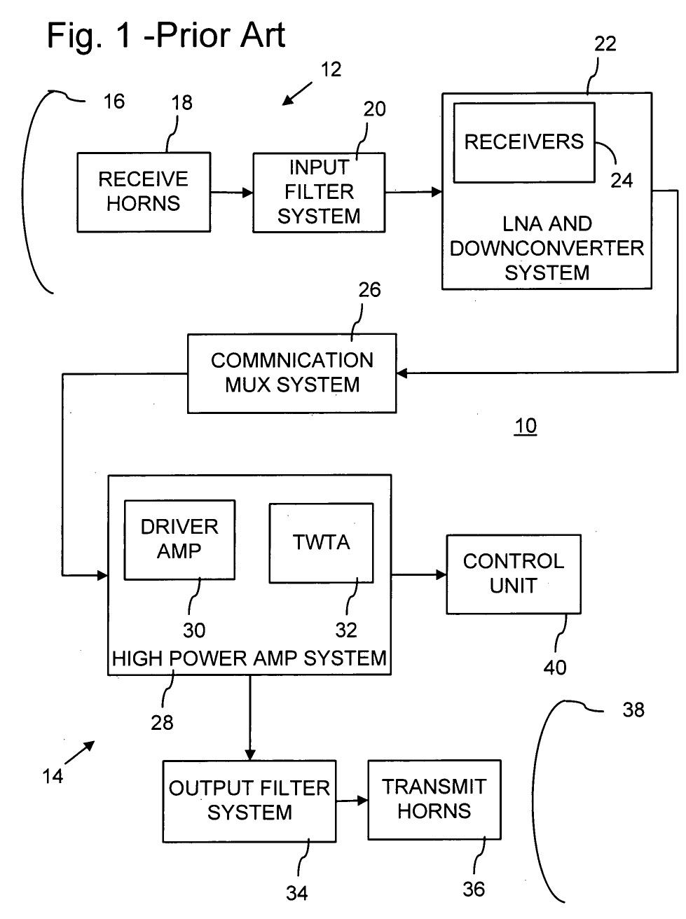

FIG. 1 is a block diagram of a prior art implementation of a communication satellite 10 for geosynchronous orbit, as described in U.S. Pat. No. 6,275,479 and assigned to Spacecode LLC, the assignee of the present invention. Communication satellite 10 has a communication signal receiving system 12 and a communication signal transmitting system 14. Receiving system 12 includes a satellite receiving reflector 16 that receives multiple communication uplink signals from one or more terrestrial transmitting stations and concentrates the signals at corresponding ones of multiple receiving horns 18. Receiving horns 18 pass the communication uplink signals through an input filter system 20 to a satellite low noise amplifier (LNA) and downconverter system 22 having multiple individual receivers 24. Each of the uplink communication signals may include multiple separate signals.

Low noise amplifier (LNA) and downconverter system 22 would typically include more individual receivers 24 than are necessary for the number of signals or channels to be handled by satellite 10. The additional receivers 24, or other components, provide redundancy and may be utilized upon the failure of any individual component. Such redundancy is typically utilized in satellite design and may be applied as well as in other systems within satellite 10 that are described below.

Accordingly, low noise amplifier (LNA) and downconverter system 22 includes switching arrays to route each channel of the uplink signal to the corresponding active receivers 24 that provide pre-amplification of the uplink communication signals and convert them to another (e.g., lower) frequency. For example, uplink signals may be Ku-band signals (i.e., about 14 GHz) or V-band signals (i.e. about 49-50 GHz), which may be converted to lower Ku-band frequencies (e.g., 11-12 GHz). A communication multiplexer system 26 receives the low noise amplified and frequency converted uplink signals and channelizes and routes the signals to appropriate ones of redundant high power amplifiers in a high power amplifier system 28 in transmitting system 14 for transmission to terrestrial recipient stations. In an implementation utilizing FDMA routing techniques, multiplexer 26 channelizes and routes the signals according to their carrier frequencies.

Amplifier system 28 may employ, for example, driver amplifiers 30 with associated traveling wave tube amplifiers 32. Traveling wave tube amplifiers 32 provide high reliability, high power output amplification. The outputs of high power amplifier system 28 are connected through an output filter system 34 to one or more transmit horns 36 for transmission as a downlink signal via a satellite transmit reflector 38. A control unit 40 is bus connected to various ones of these components to control their operation and interaction. The satellite includes power sources, orientation and position control systems, communication control systems, etc. as are known in the art.

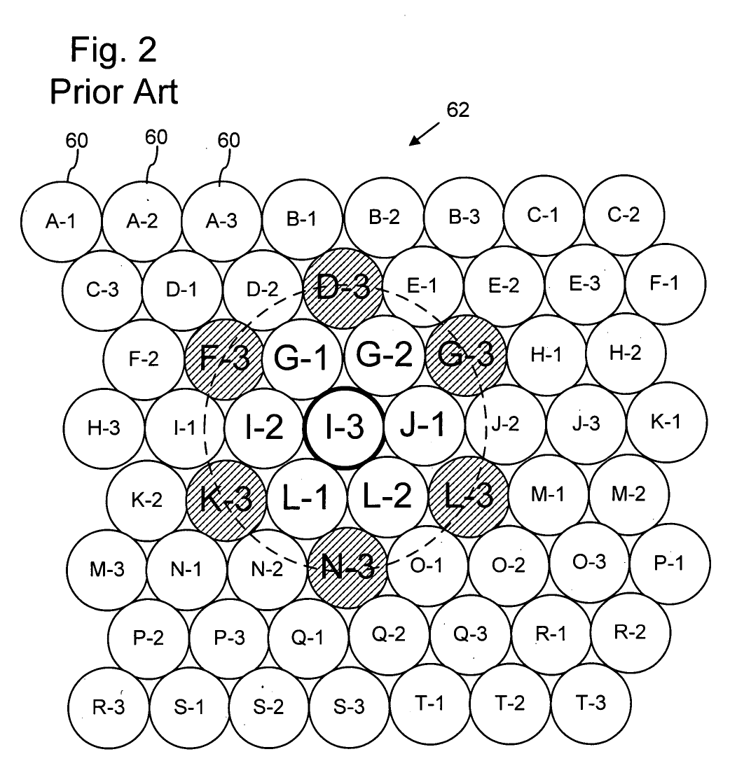

FIG. 2 is a prior art illustration of a satellite telecommunications region 50 having multiple cells 60 (represented by circles) to which prior art satellite 10 directs narrow zone communication signals to recipient stations. Cells 60 correspond to different geographic areas within region 50. Different groups of cells 60 receive downlink signals carried on different channels. In some applications, for example, the downlink signal carried on a single channel could be directed to a single cell 60. As is known in the art, transmit horns 36 are arranged in relation to transmit reflector 38 to transmit particular communication signals to particular ones of cells 60.

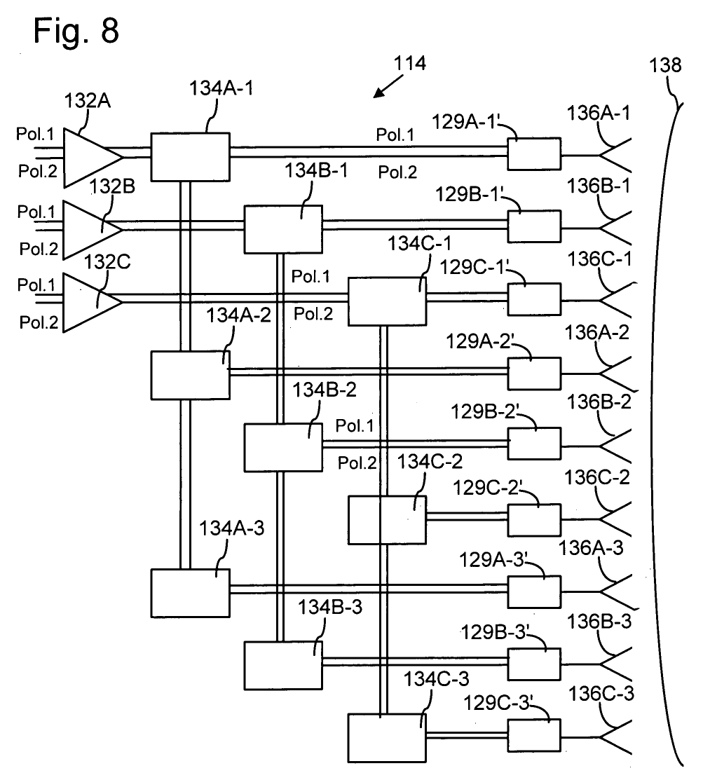

Prior art FIG. 2 illustrates geographic cells 60 with recipient stations that receive narrow zone communication downlink signals carried on different channels with 1×3 multiplexing, as described below in greater detail. Cells 60 are designated by alpha-numeric indicators that correspond to particular multiplexed communication channel sub-bands. For example, cells 60 designated A-1, A-2, and A-3 could receive respective communication sub-bands 12.200-12.367 Ghz, 12.367-12.533 Ghz, and 12.533-12.700 Ghz from a TWT amplifier 132A (FIG. 8). Similarly, each of the remaining cells 60 with the numeric suffices −1, −2, and −3 could receive respective communication sub-bands 12.200-12.367 Ghz, 12.367-12.533 Ghz, and 12.533-12.700 Ghz from a corresponding TWT amplifier 32 having a matching alphabetic designation of B-T. Accordingly, all of cells 60 having the same numeric suffix −1, −2, or −3 receive the same communication channel sub-band, although typically different communication signals.

The generally 50 percent lateral offset between successive rows of cells 60 provides a dense-packed or “honeycombed,” optionally overlapping, arrangement that minimizes (as shown) or eliminates the portions of region 50 not served by a satellite 10. In addition, with at least 1×3 multiplexing of TWT power amplifiers 32, cells 60 can be arranged to provide spatial separation between cells designated to receive the same channel sub-band. As a result, no two adjacent cells is designated to receive the same channel sub-band. This can be seen from the absence of any two adjacent cells having the same numeric suffix −1, −2, or −3. This eliminates interference between adjacent cells 60 because recipient stations in adjacent cells are tuned to receive different communication channel sub-bands.

With reference to an arbitrary cell I-3 (outlined in bold), for example, the immediately adjacent cells G-2, I-2, and L-2 and G-1, J-1, and L-1 operate at different sub-bands that do not interfere with cell I-3. It will be appreciated, however, that the next-adjacent cells D-3, F-3, G-3, K-3, L-3, and N-3 (illustrated as being centered about a dashed-line circle) receive the same sub-band and thereby can cause discernible interference with cell I-3. The signal-to-noise ratio (S/N) within cell I-3 may be represented as:
S/N=C/(N+Int),
where C is the carrier power of the sub-band directed to cell I-3, N is the noise, and Int is the interference from the next-adjacent cells (i.e., cells D-3, F-3, G-3, K-3, L-3, and N-3) receiving the same sub-band.

With noise N being a generally the same across cells, the interference-induced signal-to-noise ratio (S/Nᵢₙₜ) may be represented as:
S/Nᵢₙₜ=C/Int.
Within this context, for example, the interference-induced signal-to-noise ratio (S/Nᵢₙₜ) is a maximum of about 20 dB at the center of cell I-3 and decreases to about 12 dB at the periphery of the cell. A consequence of such a range of signal-to-noise ratios within a cell is that signal integrity and reliability is decreased at the cell peripheries.

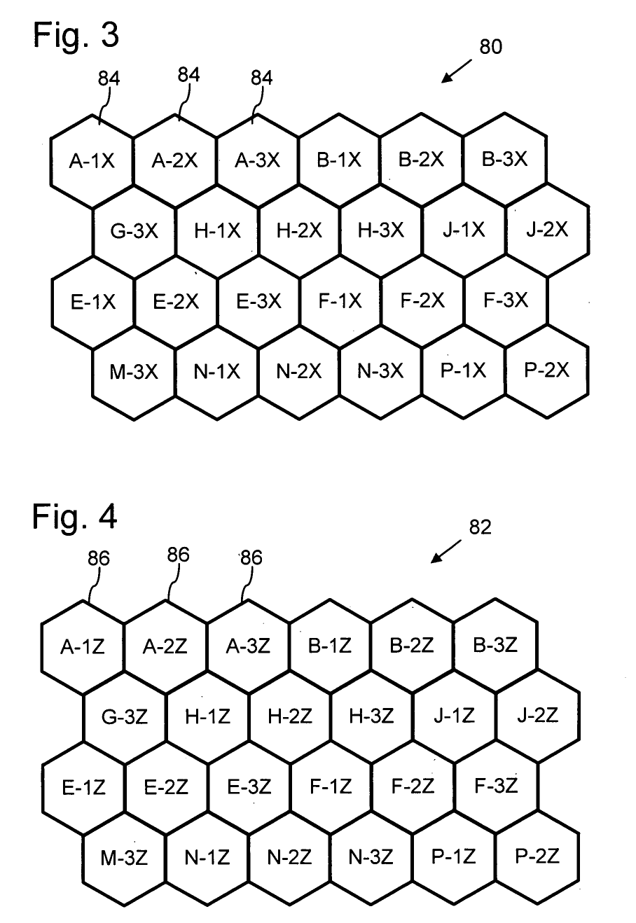

FIGS. 3 and 4 illustrate respective first and second cell patterns 80 and 82 of geographic cells 84 and 86 according to the present invention where recipient stations receive narrow zone communication downlink signals carried on different channels with 1×3 multiplexing, as described below in greater detail. Cells 84 and 86 are designated by alpha-numeric indicators that correspond to particular multiplexed communication channel sub-bands.

Cells 84 and 86 are drawn with hexagonal configurations to provide graphic illustration of the effective coverage areas provided by a close-packed arrangement of the cells. It will be appreciated, however, that the downlink beams transmitted to cells 84 and 86 would typically encompass generally circular geographical regions.

For example, cells 84 and 86 designated A-1, A-2, and A-3 could receive respective communication sub-bands 12.200-12.367 Ghz, 12.367-12.533 Ghz, and 12.533-12.700 Ghz. Similarly, each of the remaining cells 84 and 86 with the numeric suffices −1, −2, and −3 could receive respective communication sub-bands 12.200-12.367 Ghz, 12.367-12.533 Ghz, and 12.533-12.700 Ghz. All of cells 84 and 86 having the same numeric suffix −1, −2, or −3 receive the same communication channel sub-band, although typically different communication signals. In addition, each of cells 84 and 86 includes a suffix X or Z indicating that the cell receives downlink signals with a first or a second polarization. The first and second polarizations are orthogonal to each other, such as vertical and horizontal polarizations or right- and left-circular polarizations.

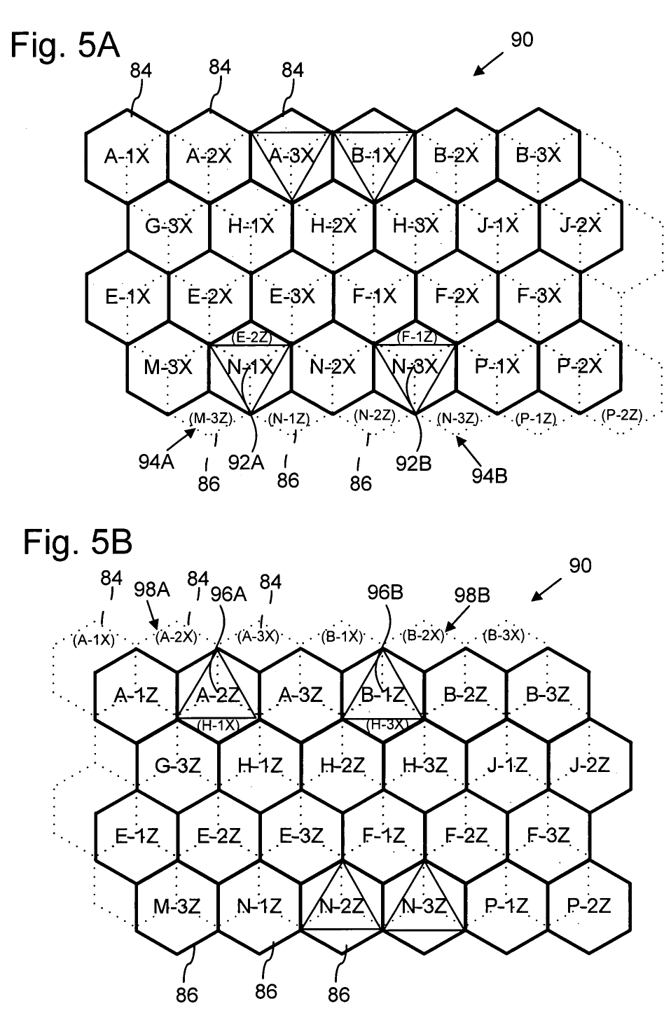

FIGS. 5A and 5B illustrate an overlapping arrangement 90 of cell patterns 80 and 82. For purposes of clarity in the illustrations, FIG. 5A shows cell pattern 80 with overlapping cell pattern 82 drawn with dashed lines, and FIG. 5B shows cell pattern 82 with overlapping cell pattern 80 drawn with dashed lines.

In FIG. 5A cells 86 designated of cell arrangement 82 are labeled parenthetically, and in FIG. 5B cells 84 designated of cell arrangement 82 are labeled parenthetically. Overlapping arrangement 90 in FIGS. 5A and 5B represents the same combination of cell patterns 80 and 82, but only one of cell patterns 80 and 82 is rendered in detail at a time to avoid excessive clutter in the drawings.

As illustrated in FIG. 5A, cells 84 (in solid lines) of cell arrangement 80 (FIG. 3) are positioned to be generally centered at about the intersections or interstices 92 between adjacent cells 86 (in dashed lines) of cell arrangement 82 (FIG. 4). In the illustrated implementation, cells 84 (in solid lines) are generally centered at about the intersections or interstices 92 between a two-dimensional group 94 of adjacent cells 84. Group 94 is two-dimensional in that the adjacent cells 84 are not co-linear with each other and, as a result, include more than just one adjacent pair of cells 84.

For example, a cell 84 designated N-1X is centered at an interstice 92A of a two-dimensional group 94A of cells 86 designated E-2Z, M-3Z, and N-1Z. Likewise, a cell 84 designated N-3X is centered at an interstice 92B of a two-dimensional group 94B of cells 86 designated F-1Z, N-2Z, and N-3Z.

As illustrated in FIG. 5B, cells 86 (in solid lines) of cell arrangement 82 (FIG. 4) are positioned to be generally centered at about the intersections or interstices 96 between adjacent cells 84 (in dashed lines) of cell arrangement 80 (FIG. 3). In the illustrated implementation, cells 86 (in solid lines) are generally centered at about the intersections or interstices 96 between a two-dimensional group 98 of adjacent cells 86. Group 98 is two-dimensional in that the adjacent cells 86 are not co-linear with each other and, as a result, include more than just one adjacent pair of cells 86.

For example, a cell 86 designated A-2Z is centered at an interstice 96A of a two-dimensional group 98A of cells 84 designated A-2X, A-3X, and H-1X. Likewise, a cell 86 designated B-1Z is centered at an interstice 96B of a two-dimensional group 98B of cells 84 designated B-1X, B-2X, and H-3X.

With reference to FIG. 5A, cells 84 (in solid lines) centered at about interstices 92 between cells 86 (in dashed lines) have central regions 100 (illustrated by triangles). In central regions 100 cells 84 receive generally maximal power levels and cells 86 of each group 94 receive generally minimal power levels along their respective edges. As a result, central regions 100 are have relatively high signal-to-noise ratios and minimal interference due to the large power disparity between and the orthogonal polarizations of the corresponding cell 84 and overlapped group of cells 86.

With reference to FIG. 5B, cells 86 (in solid lines) centered at about interstices 96 between cells 84 (in dashed lines) have central regions 102 (illustrated by triangles). In central regions 102 cells 86 receive generally maximal power levels and cells 84 of each group 98 receive generally minimal power levels along their respective edges. As a result, central regions 102 are have relatively high signal-to-noise ratios and minimal interference due to the large power disparity between and the orthogonal polarizations of the corresponding cell 86 and overlapped group of cells 84.

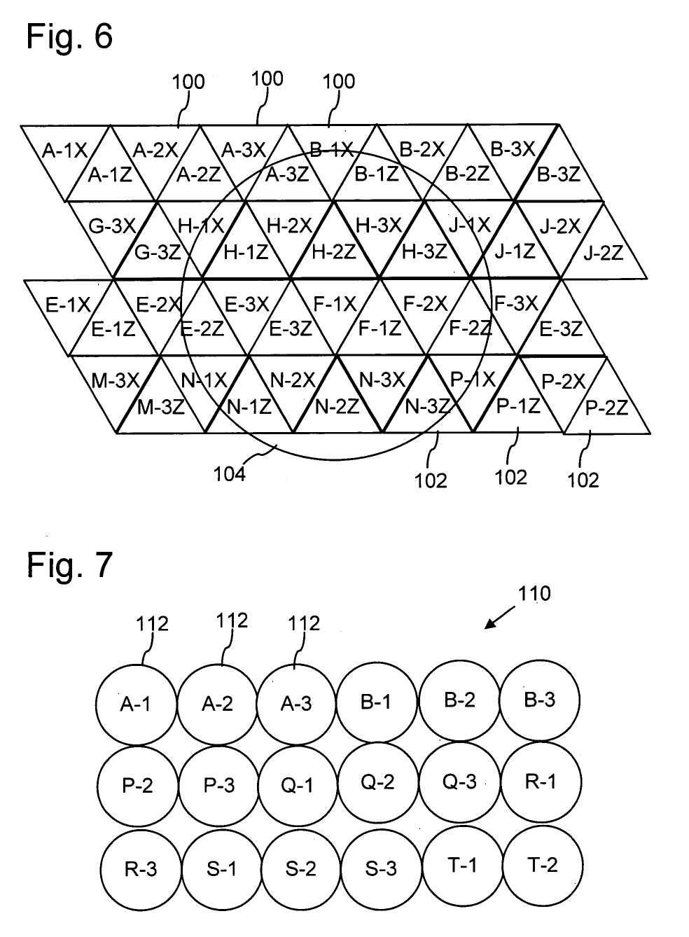

FIG. 6 illustrates a resulting close-packed arrangement of central regions 100 and 102 of respective cells 84 and 86. FIG. 6 corresponds, therefore, to the combination of central regions represented in FIGS. 5A and 5B.

Central regions 100 of the cells 84 in array 80 are substantially surrounded by the central regions 102 of the cells 86 in array 82. Likewise, central regions 102 of the cells 86 in array 82 are substantially surrounded by the central regions 100 of the cells 84 in the array 80. For example, a central region 100 designated F-1X of a cell 84 in array 80 is substantially surrounded by central regions 102 designated H-2Z, E-3Z, and F-1Z of cells 86.

As described above, the designations −1, −2, and −3 for cells 84 and 86 represent distinct communication channel sub-bands. As illustrated in FIG. 3, immediately adjacent geographic cells 84 of array 80 do not receive communication signals on the same communication sub-bands. As illustrated in FIG. 4, immediately adjacent geographic cells 86 of array 82 do not receive communication signals on the same communication sub-bands.

With these arrangements of communication channel sub-bands among the cells 84 and 86, the central region of a cell (e.g., designated F-1X in FIG. 6) of a selected polarization (e.g., polarization X) and a selected communication sub-band (e.g., sub-band −1) is separated from an adjacent central region of a cell of the same selected polarization and selected communication sub-band (e.g., cells designated N-1X, H-1X, B-1X, J-1X, and P-1X) by at least the full extent of the central region of a cell having a polarization or a sub-band different from the selected polarization and the selected communication sub-band (e.g., cells designated E-3Z, H-1Z, H-2Z, H-3Z, and F-1Z).

FIG. 6 illustrates that separation between a selected cell designated F-1X and cells of the same polarization and communication sub-band by a circle 104. This separation of each cell central region 100 or 102 from a potentially interfering cell central region by the full extent of a non-interfering cell central region decreases interference between cells and thereby increases their signal-to-noise ratios. In contrast, prior close-packed arrangements of cells as illustrated in FIG. 2 provide separation between potentially interfering cells of only about 70% of the extent of an interposed cell. For example, the cell 60 designated I-3 in FIG. 2 is separated from a cell designated K-3 (and the other interfering cells) by about 70% of the extent or diameter of the cells designated I-2 and L-1.

In one exemplary implementation, cells 84 and 86 could have a peak signal-to-noise ratio of about 20 dB within their respective central regions 100 and 102, and decreased signal-to-noise ratios of about 12 dB at their peripheries or edges. Use of central regions 100 and 102 from first and second arrays of cells with orthogonal polarizations as illustrated in FIG. 6 results in improved signal-to-noise ratios at the edges of central regions 100 and 102. In one implementation, the signal-to-noise ratios at the edges of central regions 100 and 102 improve by about 1.5 dB over the signal-to-noise ratios of prior cell arrangements as illustrated in FIG. 2. Such an incremental improvement in signal-to-noise ratio uniformity can noticeably improve signal reliability or allow the finite communication signal power to be allocated to more areas.

The present invention has been described with reference to close-packed arrays 80 and 82 of respective cells 84 and 86. It will be appreciated, however, that cells 84 and 86 could alternatively be arranged in arrays lower packing efficiencies. For example, cells 84 and 86 could each be arranged in a array with the centers of the cells aligned along perpendicular lines. FIG. 7 is an illustration of one such array 110 with geographic cells 112 arranged in a right-regular array with lower packing efficiency.

FIG. 8 is a circuit block diagram of a communication signal transmitting system 114 including diplexers 129 that combine and deliver to horns 136 combined communication signals of first and second orthogonal polarizations, referred to as orthogonal communication signals. Communication signal transmitting system 114 includes multiplexed traveling wave tube (TWT) amplifiers 132 (only three shown) according to the present invention that receive the orthogonal communication signals. Each TWT amplifier 132 is multiplexed among three transmit horns 136. Each transmit horn 136 transmits the orthogonal communication signals as downlink communication signals to corresponding cells 84 or 86 (FIGS. 3 and 4). It will be appreciated, however, that the illustrated 1×3 multiplexing is merely exemplary and that greater degrees of multiplexing can be applied to TWT power amplifiers 132.

With reference to TWT amplifier 132A, for example, three output frequency filters 134A-1, 134A-2, and 134A-3 pass different portions or segments of a given output frequency band for signals of each polarization to respective transmit horns 136A-1, 136A-2, and 136A-3. As one example, each TWT amplifier 132, including TWT amplifier 132A, is adapted to amplify and transmit all of the nominal 500 MHz bandwidth of a Ku-band downlink communication channel. Accordingly, output frequency filters 134A-1, 134A-2, and 134A-3 pass signals with frequencies within different nominal 167 MHz sub-bands of the Ku-band channel. With a Ku-band downlink communication channel of 12.200-12.700 GHz, frequency filter 34A-1 could pass communication signals for frequencies in the sub-band 12.200-12.367 Ghz, frequency filter 134A-2 could pass communication signals for frequencies in the sub-band 12.367-12.533 Ghz, and frequency filter 134A-3 could pass communication signals for frequencies in the sub-band 12.533-12.700 Ghz. It will be appreciated that references to the KU-band downlink communication channel is only illustrative and is not a limitation on the scope of application for transmitting system 114.

In an alternative implementation, a communication signal transmitting system could employ first and second separate sets of transmit horns and first and second reflectors to accommodate the respective communication signals of first and second orthogonal polarizations.

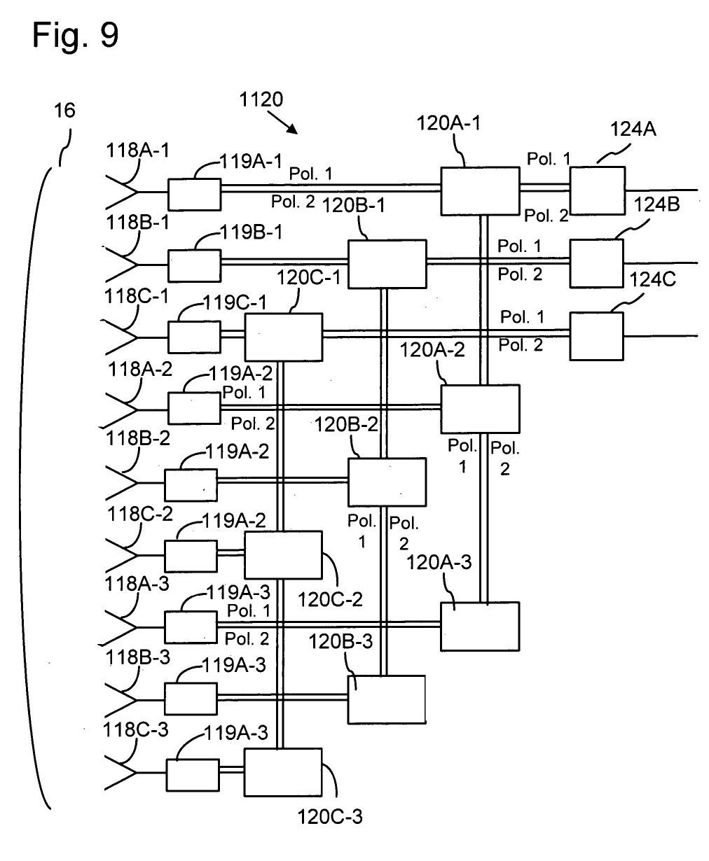

FIG. 9 is a circuit block diagram of a communication signal receiving system 120 with receivers 124 (only three shown) that are multiplexable and receive communications signals of first and second orthogonal polarizations, referred to as orthogonal communication signals.

In the illustrated implementation, each of receivers 124A-124C is multiplexable among three receive horns 118. Each receive horn 118 receives from a transmitting station a combined uplink communication signal that is separated into orthogonal communication signals by a diplexer 119 to be transmitted to different respective cells. It will be appreciated that such 1×3 multiplexing is merely exemplary and that different degrees of multiplexing, or no multiplexing at all, can be applied to receivers 124A-124C.

With reference to receiver 24A, for example, diplexers 119A-1, 119A-2, and 119A-3 deliver to respective input frequency filters 120A-1, 120A-2, and 120A-3 different portions or segments of given uplink frequency bans of the orthogonal polarizations. As one example, each of receivers 124A-124C, including receiver 124A, is adapted to receive and amplify all of the nominal 500 MHz bandwidth of a Ku-band uplink communication channel of each polarization. Accordingly, input frequency filters 120A-1, 120A-2, and 120A-3 pass signals with frequencies within different nominal 167 MHz sub-bands of the Ku-band channel for each polarization. With a Ku-band downlink communication channel of 12.200-12.700 GHz, frequency filter 120A-1 could pass communication signals for frequencies in the sub-band 12.200-12.367 Ghz, frequency filter 120A-2 could pass communication signals for frequencies in the sub-band 12.367-12.533 Ghz, and frequency filter 120A-3 could pass communication signals for frequencies in the sub-band 12.533-12.700 Ghz. It will be appreciated that references to the KU-band uplink communication channel is only illustrative and is not a limitation on the scope of application for receiving system 120.

In an alternative implementation, a communication signal receiving system could employ first and second separate sets of receive horns and first and second reflectors to accommodate the respective communication signals of first and second orthogonal polarizations.

The present invention has been described with respect to embodiments in which multiple signals of first and second orthogonal polarizations are transmitted to overlapping first and second arrays of cells. The overlapping arrays of cells receiving orthogonal polarizations decrease interference between adjacent cells. It will be appreciated that in alternative implementations multiple signals of distinct first and second signal bands or frequency ranges may be transmitted to overlapping first and second arrays of cells. In these alternative implementations the distinct or different signal bands or frequency ranges would provide non-interfering signal distinctions, rather than relying upon signal polarizations. These alternative implementations could employ substantially the same structural elements described above with reference to implementations utilizing orthogonal polarizations.

In view of the many possible embodiments to which the principles of our invention may be applied, it should be recognized that the detailed embodiments are illustrative only and should not be taken as limiting the scope of our invention. Accordingly, the invention includes all such embodiments as may come within the scope and spirit of the following claims and equivalents thereto.

1. A communication satellite having plural communication signal amplifiers coupled to plural transmit horns that transmit communication signals to plural corresponding geographic cells, the improvement comprising:
a first set of communication signal amplifiers and transmit horns that cooperate to deliver plural distinct communication signals of a first polarization to a first array of plural adjacent geographic cells having first interstices between them; and
a second set of communication signal amplifiers and transmit horns that cooperate to deliver plural distinct communication signals of a second polarization to a second array of plural adjacent geographic cells having second interstices between them, the second polarization being orthogonal to the first polarization and the adjacent geographic cells of the second array generally being centered at the first interstices and substantially overlapping geographic cells of the first array.

2. The satellite of claim 1 in which cells in the respective first and second arrays are in close-packed arrangements with each other.

3. The satellite of claim 1 in which the cells in the first and second arrays include central regions with increased signal-to-noise ratios and the positioning of the cells in the first and second arrays provides a close-packed arrangement of the central regions of the cells in the first and second arrays.

4. The satellite of claim 3 in which the central regions of the cells in the first array are substantially surrounded by the central regions of the cells in the second array and in which the central regions of the cells in the second array are substantially surrounded by the central regions of the cells in the first array.

5. The satellite of claim 1 in which each of the communication signal amplifiers delivers plural distinct communication signals to plural respective transmit horns on a common set of frequency-distinct communication sub-bands and the transmit horns are coupled to the communication signal amplifiers so that immediately adjacent geographic cells of the respective first and second arrays do not receive communication signals on the same communication sub-bands.

6. The satellite of claim 5 in which the cells in the first and second arrays include central regions with increased signal-to-noise ratios and the positioning of the cells in the first and second arrays provides a close-packed arrangement of the central regions of the cells in the first and second arrays.

7. The satellite of claim 6 in which the central region of a cell of a selected polarization and a selected communication sub-band is separated from an adjacent central region of a cell of the selected polarization and selected communication sub-band by at least the full extent of the central region of a cell having a polarization or a sub-band different from the selected polarization and the selected communication sub-band.

8. A satellite communication method that includes transmitting communication signals to plural geographic cells, the method comprising:
delivering plural distinct communication signals of a first polarization to a first array of plural adjacent geographic cells having first interstices between them; and
delivering plural distinct communication signals of a second polarization to a second array of plural adjacent geographic cells having second interstices between them, the second polarization being orthogonal to the first polarization and the adjacent geographic cells of the second array generally being centered at the first interstices and substantially overlapping geographic cells of the first array.

9. The method of claim 8 in which cells in the respective first and second arrays are in close-packed arrangements with each other.

10. The method of claim 8 in which the cells in the first and second arrays include central regions with increased signal-to-noise ratios and the positioning of the cells in the first and second arrays provides a close-packed arrangement of the central regions of the cells in the first and second arrays.

11. The method of claim 10 in which the central regions of the cells in the first array are substantially surrounded by the central regions of the cells in the second array and in which the central regions of the cells in the second array are substantially surrounded by the central regions of the cells in the first array.

12. The method of claim 8 in which delivering plural distinct communication signals of the first and second polarizations includes delivering the plural distinct communication signals on a common set of frequency-distinct communication sub-bands, whereby immediately adjacent geographic cells of the respective first and second arrays do not receive communication signals on the same communication sub-bands.

13. The method of claim 12 in which the cells in the first and second arrays include central regions with increased signal-to-noise ratios and the positioning of the cells in the first and second arrays provides a close-packed arrangement of the central regions of the cells in the first and second arrays.

14. The method of claim 13 in which the central region of a cell of a selected polarization and a selected communication sub-band is separated from an adjacent central region of a cell of the selected polarization and selected communication sub-band by at least the full extent of the central region of a cell having a polarization or a sub-band different from the selected polarization and the selected communication sub-band.

15. A communication satellite having plural communication signal amplifiers coupled to plural transmit horns that transmit communication signals to plural corresponding geographic cells, the improvement comprising:
a first set of communication signal amplifiers and transmit horns that cooperate to deliver plural distinct communication signals of a first signal characteristic to a first array of plural adjacent geographic cells having first interstices between them; and
a second set of communication signal amplifiers and transmit horns that cooperate to deliver plural distinct communication signals of a second signal characteristic to a second array of plural adjacent geographic cells having second interstices between them, the second signal characteristic being distinctive relative to the first signal characteristic and the adjacent geographic cells of the second array generally being centered at the first interstices and substantially overlapping geographic cells of the first array.

16. The satellite of claim 15 in which the first and second signal characteristics relate to signal polarizations, signal frequencies, or both.

17. The satellite of claim 15 in which the first and second signal characteristics relate to signal frequencies.

18. The satellite of claim 15 in which the cells in the first and second arrays include central regions with increased signal-to-noise ratios and the positioning of the cells in the first and second arrays provides a close-packed arrangement of the central regions of the cells in the first and second arrays.

19. The satellite of claim 15 in which each of the communication signal amplifiers delivers plural distinct communication signals to plural respective transmit horns on a common set of frequency-distinct communication sub-bands and the transmit horns are coupled to the communication signal amplifiers so that immediately adjacent geographic cells of the respective first and second arrays do not receive communication signals on the same communication sub-bands.
